(19) United States
(12) Patent Application Publication
(10) Pub. No.: US 2014/0253691 A1
(43) Pub. Date: Sep. 11, 2014

(54) MOTION-CAPTURE APPARATUS WITH LIGHT-SOURCE FORM FACTOR

(71) Applicant: Leap Motion, Inc., San Francisco, CA (US)

(72) Inventor: David Holz, San Francisco, CA (US)

(73) Assignee: LEAP MOTION, INC., San Francisco, CA (US)

(21) Appl. No.: 14/198,392

(22) Filed: Mar. 5, 2014

Related U.S. Application Data
(60) Provisional application No. 61/773,246, filed on Mar. 6, 2013.

(51) Int. Cl. H04N 13/02; G06T 7/20

(52) U.S. Cl. CPC H04N 13/0203; H04N 13/0239; G06T 7/2086
USPC 348/47; 348/46

(57) ABSTRACT

A system which identifies the position and shape of an object in 3D space includes a housing having a base portion and a body portion, the base portion including electrical contacts mating with a lighting receptacle. A camera, an image analyzer and power conditioning circuitry are within the housing. The image analyzer, coupled to the camera for receipt of camera image data, is configured to capture at least one image of the object and to generate object data indicative of the position and shape of the object in 3D space. The power conditioning circuitry converts power from the lighting receptacle to power suitable for the system. The object data can be used to computationally construct a representation of the object. Some examples include a database containing a library of object templates, the image analyzer being configured to match the 3D representation to one of the templates.

### CROSS-REFERENCE TO OTHER APPLICATIONS

This application claims the benefit of U.S. provisional patent application No. 61/773,246, filed 6 Mar. 2013, entitled Motion-Capture Apparatus with Light-Source Form Factor.

### BACKGROUND

The present technology relates, in general, to motion capture and image analysis, and, in particular embodiments, to systems having input modules distributable among lighting fixtures.

Security systems deployed to monitor homes and businesses typically utilize a combination of sensors to detect intrusion. These include magnetic sensors that detect opening of a door or window; acoustic sensors that detect characteristic signatures of, for example, breaking glass; and motion sensors that detect movement within a spatial volume addressable by the sensor. Motion sensors are often deployed as standalone units mounted, for example, in a ceiling corner of a room, but sometimes they are instead contained within units that screw into the sockets of standard lighting fixtures. Such units can do “double duty” as light sources and motion detectors; for example, they may be shaped to resemble conventional light bulbs, and can be equipped with appropriate power-conversion circuitry and a threadable base for compatibility with incandescent fixtures.

Motion sensing for security purposes tends to be quite rudimentary; motion over a large enough spatial region to exceed an internal sensor threshold triggers the detection signal, which may, for example, activate an alarm. Most sensors cannot detect the nature of the motion or characterize the object producing it. As a consequence, motion sensors tend to be deployed in areas where, during periods of active monitoring, virtually any movement can be considered suspicious. This means that motion sensors are typically not deployed in houses (or rooms) where pets roam free, and cannot discriminate between ordinary and suspicious activities.

### BRIEF SUMMARY

A system for identifying the position and shape of an object in three-dimensional (3D) space includes a housing having a base portion and a body portion, the base portion including electrical contacts for mating with a lighting receptacle. At least one camera, an image analyzer and power conditioning circuitry are within the housing. The camera is oriented toward a field of view through a port in the housing. The image analyzer is coupled to the camera for receipt of image data from the camera. The image analyzer is configured to capture at least one image of the object and to generate object data indicative of the position and shape of the object in 3D space. The power conditioning circuitry converts power supplied to the lighting receptacle to power suitable for operating the camera and the image analyzer.

The object position and shape identifying system can include one or more the following. A transmitter circuit can transmit the object data to an external computer system for computationally reconstructing the object. A lighting unit within the housing can be used to provide ambient light to the 3D space. The image analyzer can be further configured to (1) slice the object into a plurality of two-dimensional (2D) image slices, each slice corresponding to a cross-section of the object, (2) identify a shape and position of the object based at least in part on an image captured by the image analyzer and the location of the housing, and (3) reconstruct the position and shape of the object in 3D space based at least in part on a plurality of the 2D image slices. The camera can include a plurality of cameras each having an optical axis extending radially from the housing and displaced from the other optical axes; at least two of the fields of view of the cameras can overlap one another to create an overlapped region, so that when the object is within the overlapped region, image data from said cameras creating the overlapped region can be used to generate object data in 3D.

A distributed system for identifying the position and shape of an object in three-dimensional (3D) space includes a plurality of sensors. Each sensor includes a housing having a base portion and a body portion, the base portion including electrical contacts for mating with a lighting receptacle. At least one camera, an image analyzer and power conditioning circuitry are within the housing. The camera is oriented toward a field of view through a port in the housing. The image analyzer is coupled to the camera for receipt of image data from the camera, the image analyzer configured to capture at least one image of the object and to generate object data indicative of a position and shape of the object in 3D space. The power conditioning circuitry converts power supplied to the lighting receptacle to power suitable for operating the camera and the image analyzer. A transmitter transmits the object data. A computer receives the object data from the sensors and computationally constructs a representation of the object from the object data. Some examples include a database containing a library of object templates, the computer being configured to match the 3D representation to one of the templates.

Other features, aspects and advantages of the technology disclosed in can be seen on review the drawings, the detailed description, and the claims which follow.

### BRIEF DESCRIPTION OF THE DRAWINGS

FIG. 1A illustrates a representative configuration of a motion-capture device.

FIG. 1B illustrates the basic components of representative motion capture circuitry integrated within the housing of the motion-capture device of FIG. 1A.

FIG. 2 is a simplified block diagram of an example of circuitry implementing the computer of FIG. 1B.

### DESCRIPTION

Embodiments of the technology disclosed provide sophisticated motion-capture systems housed in packages that allow them to be screwed or otherwise installed into conventional lighting fixtures, but which can capture and characterize movement at a detailed enough level to permit discrimination between, for example, a human and a pet, as well as between harmless and malicious activity (such as shoplifting). In some embodiments, the motion capture (“mocap”) output of two or more sensors deployed around a spatial volume of interest may be combined into a fully three-dimensional (3D) representation of moving objects within the space, allowing a user (or an automated analysis system) to, for example, select an angle of view and follow a moving object from that vantage as the object moves through the monitored space, or to vary the angle of view in real time.

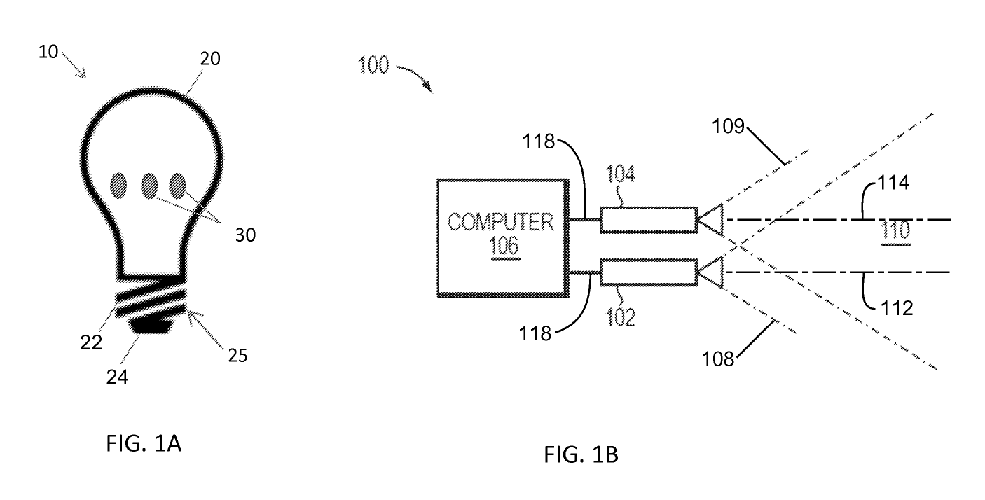

Refer first to FIGS. 1A and 1B. FIG. 1A illustrates a representative configuration of a motion-capture device. The illustrated device 10 is configured with the form factor of an incandescent light bulb, including a contoured housing 20, also referred to as body portion 20, and a conventional base 25. The base 25 mates with an Edison screw socket, i.e., contains standard threads 22 and a bottom electrical contact 24 in the manner of a conventional light bulb.

Threads 22 and contact 24 act as electrical contacts for device 10. Also contained within the housing 20 is circuitry as described below and one or more optical ports 30 through which a camera may record images. The ports may be simple apertures, transparent windows or lenses. In some examples, base 25 can include prongs mateable with a halogen lamp socket. In other examples, base 25 is formed as two opposed bases separated by body portion 20 and configured to be received within a fluorescent tube receptacle.

FIG. 1B illustrates the basic components of representative mocap circuitry 100 integrated within the housing 20 of device 10. The mocap circuitry 100 includes two cameras 102, 104 arranged such that their fields of view 108, 109, indicated by broken lines, overlap in region 110; the optical axes 112, 114 of cameras 102, 104 pass through the ports 30 of the housing 20, and are coupled to provide image data to a computer 106. Computer 106 acts as an image analyzer and analyzes the image data 118 from cameras 102, 104 to determine the 3D position and motion of an object that moves in the field of view of cameras 102, 104. As will become apparent, the processing capabilities of the computer 106 can vary with the application; while in some embodiments, the computer 106 performs all processing necessary to object characterization and reconstruction, in other embodiments, the computer 106 does not perform all of the processing or, indeed, may simply pre-process the image data 118 and transmit it typically wirelessly—to an external computer. Moreover, an external computer may integrate image data from several devices 10 to create a full 3D reconstruction of the moving object, and a user, operating the external computer, can vary a displayed view of the object through 360° or can maintain a consistent view of the object as it moves and changes orientation.

Cameras 102, 104 can be any type of camera, including visible-light cameras, infrared (IR) cameras, ultraviolet cameras or any other devices (or combination of devices) that are capable of capturing an image of an object and representing that image in the form of digital data. Cameras 102, 104 are preferably capable of capturing video images (i.e., successive image frames at a constant rate of at least 15 frames per second), although no particular frame rate is required. The particular capabilities of cameras 102, 104 are not critical, and the cameras can vary as to frame rate, image resolution (e.g., pixels per image), color or intensity resolution (e.g., number of bits of intensity data per pixel), focal length of lenses, depth of field, etc. In general, for a particular application, any cameras capable of focusing on objects within a spatial volume of interest can be used. The cameras can be oriented in any convenient manner, and their number is determined by the angular extent of the surrounding space that will be monitored by the circuitry 100. Each camera is used to define a “vantage point” from which the object is seen, such that a location and view direction associated with each vantage point be known, so that the locus of points in space that project onto a particular position in the camera's image plane can be determined. In some embodiments, motion capture is reliable only for objects in region 110 (where the fields of view 108, 109 of cameras 102, 104 overlap), and cameras 102, 104 may be arranged to provide overlapping fields of view throughout the area where motion of interest is expected to occur.

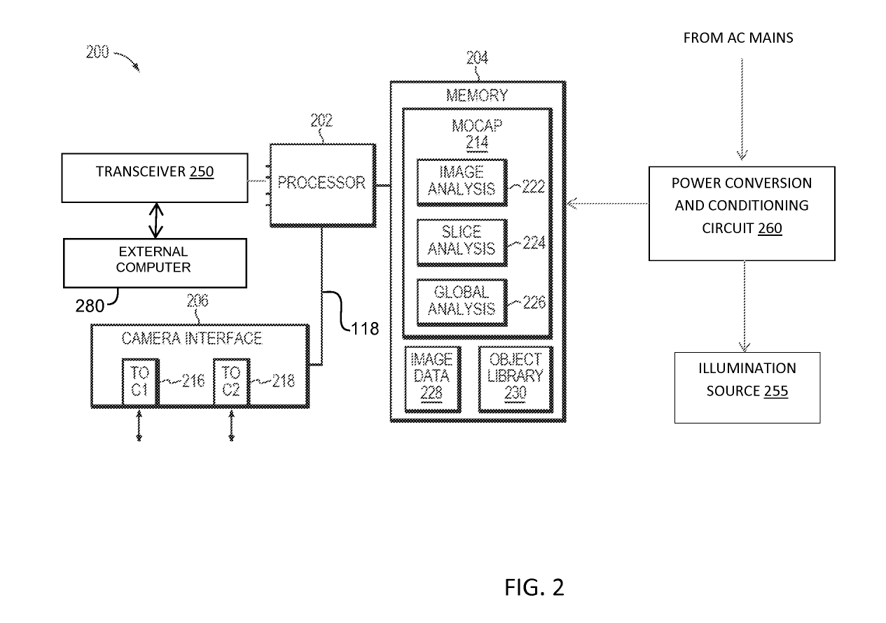

Computer 106 (which is understood to include functionality that may be shared between the on-board processor and an external computer) can be any device capable of processing image data using techniques described herein. FIG. 2 is a simplified block diagram of circuitry 200 implementing computer 106 according to an embodiment. Circuitry 200 includes a processor 202, a memory 204, and a camera interface 206. Processor 202 can be of generally conventional design and can include, e.g., one or more programmable microprocessors capable of executing sequences of instructions. Memory 204 can include volatile (e.g., DRAM) and nonvolatile (e.g., flash memory) storage in any combination. Other storage media (e.g., magnetic disk, optical disk) can also be provided. Memory 204 can be used to store instructions to be executed by processor 202 as well as input and/or output data associated with execution of the instructions.

Camera interface 206 can include hardware and/or software that enables communication between circuitry 200 and cameras such as cameras 102, 104 of FIG. 1B. Thus, for example, camera interface 206 can include one or more data ports 216, 218 to which cameras can be connected, as well as hardware and/or software signal processors to modify image data received from the cameras (e.g., to reduce noise or reformat data) prior to providing the signals as inputs to a conventional mocap program 214 executing on processor 202. In some embodiments, camera interface 206 can also transmit signals to the cameras, e.g., to activate or deactivate the cameras, to control camera settings (frame rate, image quality, sensitivity, etc.), or the like. Such signals can be transmitted, e.g., in response to control signals from processor 202, which may in turn be generated in response to user input or other detected events.

In some embodiments, memory 204 stores mocap program 214, which includes instructions for performing motion capture analysis on images supplied from cameras connected to camera interface 206. In one embodiment, mocap program 214 includes various modules, such as an image analysis module 222, a slice analysis module 224, and a global analysis module 226. Image analysis module 222 can analyze images, e.g., images captured via camera interface 206, to detect edges or other features of an object. Slice analysis module 224 can analyze image data from a slice of an image as described below, to generate an approximate cross-section of the object in a particular plane. Global analysis module 226 can correlate cross-sections across different slices and refine the analysis. Memory 204 can also include other information used by mocap program 214; for example, memory 204 can store image data 228 and an object library 230 that can include canonical models of various objects of interest. An object being modeled can, in some embodiments, be identified by matching its shape to a model in object library 230.

While circuitry 200 is described herein with reference to particular blocks, it is to be understood that the blocks are defined for convenience of description and are not intended to imply a particular physical arrangement of component parts. Further, the blocks need not correspond to physically distinct components. To the extent that physically distinct components are used, connections between components (e.g., for data communication) can be wired and/or wireless as desired.

Cameras 102, 104 may be operated to collect a sequence of images of a monitored space. The images are time correlated such that an image from camera 102 can be paired with an image from camera 104 that was captured at the same time (within a few milliseconds). These images are then analyzed, e.g., using mocap program 214, to determine the position and shape of one or more objects within the monitored space. In some embodiments, the analysis considers a stack of 2D cross-sections through the 3D spatial field of view of the cameras. These cross-sections are referred to herein as “slices.” In particular, an outline of an object's shape, or silhouette, as seen from a camera's vantage point can be used to define tangent lines to the object from that vantage point in various planes, i.e., slices. Using as few as two different vantage points, four (or more) tangent lines from the vantage points to the object can be obtained in a given slice. From these four (or more) tangent lines, it is possible to determine the position of the object in the slice and to approximate its cross-section in the slice, e.g., using one or more ellipses or other simple closed curves. As another example, locations of points on an object's surface in a particular slice can be determined directly (e.g., using a time-of-flight camera), and the position and shape of a cross-section of the object in the slice can be approximated by fitting an ellipse or other simple closed curve to the points. Positions and cross-sections determined for different slices can be correlated to construct a 3D model of the object, including its position and shape. A succession of images can be analyzed using the same technique to model motion of the object. The motion of a complex object that has multiple separately articulating members (e.g., a human hand) can also be modeled. In some embodiments, the silhouettes of an object are extracted from one or more images of the object that reveal information about the object as seen from different vantage points. While silhouettes can be obtained using a number of different techniques, in some embodiments, the silhouettes are obtained by using cameras to capture images of the object and analyzing the images to detect object edges. Further details of such modeling techniques are set forth in U.S. Ser. Nos. 13/742,953 (filed on Jan. 16, 2013), 13/414,485 (filed on Mar. 7, 2012), 61/724,091 (filed on Nov. 8, 2012) and 61/587,554 (filed on Jan. 17, 2012). The foregoing applications are incorporated herein by reference in their entireties.

With reference to FIGS. 1A, 1B and 2, circuitry 200 also includes a transceiver 250 for communicating wirelessly with an external computer 280, e.g., via an IEEE 802.11x protocol. In this way, processor 202 may perform only a portion of the image-processing operations necessary for a full computational reconstruction of an object in the region 110; wireless transmission of image data allows the computational load to be shared between processor 202 and external computer 280. For example, an object detected by the device 10 may be identified based on object library 230, which may be stored and accessed locally or externally. In a security application, for example, object library 230 may be maintained by a master alarm console that receives image data 118 from multiple distributed devices 10; the master console analyzes the image data and attempts to match detected objects to library entries to determine, e.g., whether a moving object in the monitored environment is a human or the homeowner's pet, activating or suppressing the alarm accordingly. In a retail or warehouse environment, the external computer may integrate information from multiple devices 10 to automatically track the movements of individuals from the monitored space of one device to the next, determining whether they are exhibiting behavior or following routes consistent with suspicious activity. For example, the external computer may be able to identify the same individual across multiple devices by height and gait (even if identifying an actual individual is not possible) and determine that the person is carrying objects between an inventory area and a loading dock when such activity is inappropriate. More generally, the identified object and/or detected and recognized gestures performed by someone in the monitored space can be used to drive environmental systems, displays, etc.

In various embodiments, the device 10 also functions as a lighting device, supplying the light that a conventional illumination source (installed in the socket mating with the base 25) would provide. To this end, the device 10 includes an illumination source 255 that may be, for example, one or more light-emitting diodes (LEDs) or other conventional source. LED-based replacements for incandescent bulbs are widely available, and often utilize blue-emitting LEDs in combination with a housing coated with a yellow phosphor to produce white output light. The device 10 may be configured in this fashion, with a suitable phosphor coated on or inside a portion of housing 20 (e.g., above the ports 30) and one or more LEDs located inside the housing 20. Conventional power conversion and conditioning circuitry 260 receives power from the AC mains and outputs power suitable for driving both the illumination source 255 and computational circuitry 200. It should be stressed that input power may, depending on the intended use, come from sources other than the AC mains. For example, embodiments of the device 10 can be mated with sockets for low-voltage halogen or other lamps.

The terms and expressions employed herein are used as terms and expressions of description and not of limitation, and there is no intention, in the use of such terms and expressions, of excluding any equivalents of the features shown and described or portions thereof. In addition, having described certain embodiments, it will be apparent to those of ordinary skill in the art that other embodiments incorporating the concepts disclosed herein may be used. Accordingly, the described embodiments are to be considered in all respects as only illustrative and not restrictive.

What is claimed is:

1. A system for identifying a position and shape of an object in three-dimensional (3D) space, the system comprising:
a housing including a base portion and a body portion, the base portion including electrical contacts for mating with a lighting receptacle;
within the housing,
at least one camera oriented toward a field of view through a port in the housing; and
an image analyzer coupled to the camera for receipt of image data from the camera, the image analyzer configured to capture at least one image of the object and to generate object data indicative of a position and shape of the object in 3D space; and
power conditioning circuitry for converting power supplied to the lighting receptacle to power suitable for operating the at least one camera and the image analyzer.

2. The system of claim 1, further comprising a transmitter circuit for transmitting the object data to an external computer system for computationally reconstructing the object.

3. The system of claim 1, further comprising a lighting unit within the housing for providing ambient light to the 3D space.

4. The system of claim 3, wherein the lighting unit comprises at least one light-emitting diode and a phosphor.

5. The system of claim 1, wherein the image analyzer is further configured to:
slice the object into a plurality of two-dimensional (2D) image slices, each slice corresponding to a cross-section of the object;
identify a shape and position of the object based at least in part on an image captured by the image analyzer and a location of the housing; and
reconstruct the position and shape of the object in 3D space based at least in part on a plurality of the 2D image slices.

6. The system of claim 1, wherein the base comprises threads and a contact mateable with an Edison screw socket.

7. The system of claim 1, wherein the base comprises prongs mateable with a halogen lamp socket.

8. The system of claim 1, wherein the base comprises two opposed bases separated by the body portion and configured to be received within a fluorescent tube receptacle.

9. The system of claim 1, wherein the at least one camera comprises a plurality of cameras each having an optical axis extending radially from the housing and displaced from the other optical axes.

10. The system of claim 9, wherein each said camera has a field of view, at least two of the fields of view overlapping one another to create an overlapped region, whereby when the object is within the overlapped region, image data from said cameras creating the overlapped region can be used to generate object data in 3D.

11. The system of claim 9, wherein the optical axes are angularly displaced from one another.

12. A distributed system for identifying a position and shape of an object in three-dimensional (3D) space, the system comprising:
a plurality of sensors each including:
a housing including a base portion and a body portion, the base portion including electrical contacts for mating with a lighting receptacle;
within the housing,
at least one camera oriented toward a field of view through a port in the housing; and
an image analyzer coupled to the camera for receipt of image data from the camera, the image analyzer configured to capture at least one image of the object and to generate object data indicative of a position and shape of the object in 3D space; and
power conditioning circuitry for converting power supplied to the lighting receptacle to power suitable for operating the at least one camera and the image analyzer;
a transmitter for transmitting the object data; and
a computer for receiving the object data from the sensors and computationally constructing therefrom a representation of the object.

13. The system of claim 12, further comprising an interface for permitting a user to vary a displayed view of the object through 360°.

14. The system of claim 12, wherein the computer is configured to computationally construct a 3-D representation of the object from the image data from the at least one camera.

15. The system of claim 14, wherein:
wherein the at least one camera comprises a plurality of cameras each having an optical axis extending from the housing and displaced from the other optical axes;
each said camera has a field of view, at least two of the fields of view overlapping one another to create an overlapped region; and
whereby when at least a portion of the object is within the overlapped region, image data from the plurality of cameras of said portion of the object in the overlapped region can be used to computationally construct a 3-D representation of the portion of the object from the image data from the plurality of cameras.

16. The system of claim 14, further comprising a database containing a library of object templates, the computer being configured to match the 3D representation to one of the templates.

17. An apparatus for capturing information about an object in space, the apparatus comprising:
a base portion including electrical contacts for mating with a receptacle that powers a light source; and
a body portion, the body portion enclosing:
at least one camera oriented toward a field of view through a port in the body portion to capture at least one image of the object;
a transceiver to communicate image data from the at least one camera to an image analyzer configured to generate object data indicative of a position of the object in space from the image data; and
a power conditioning circuit to convert power supplied to the receptacle to power suitable for operating the at least one camera and the transceiver.
